(19) United States
(12) Patent Application Publication
(10) Pub. No.: US 2023/0064854 A1
(43) Pub. Date: Mar. 2, 2023

(54) TRAILER

(71) Applicants: Pamela ZGRABLIC, Edmonton (CA); Ross AUSER, Devon (CA); Gregg EMMERLING, Millet (CA)

(72) Inventors: Pamela ZGRABLIC, Edmonton (CA); Ross AUSER, Devon (CA); Gregg EMMERLING, Millet (CA)

(21) Appl. No.: 17/894,577

(22) Filed: Aug. 24, 2022

(30) Foreign Application Priority Data
Aug. 26, 2021 (CA) 3 128 991

(51) Int. Cl. B60D 1/167

(52) U.S. Cl. CPC B60D 1/1675

(57) ABSTRACT

A trailer has a body frame and a tongue frame. The tongue frame has a trailer coupler at a first end and a second end that is movably attached to the body frame. The tongue frame is movable between an operational position and a stored position. The tongue frame is vertically offset from the body from such that a top of the tongue frame is lower than a bottom of the body frame. In the stored position, at least the majority of the tongue frame is positioned below the body frame. In the operational position, the tongue frame extends forward from the body frame and the second end of the tongue frame remains below the body frame. A locking mechanism holds the tongue frame in the operational position. At least one axle with wheels is provided.

### FIELD OF THE DISCLOSURE

The present application relates generally to a trailer and more specifically relates to a bumper pull trailer with retractable tongue.

### BACKGROUND

This section provides background information to facilitate a better understanding of the various aspects of the invention. It should be understood that the statements in this section of this document are to be read in this light, and not as admissions of prior art.

Horse trailers, utility trailers, holiday trailers and flat bed trailers are often seen on the roads in use, parked in lots and parked at people's homes. When not in use, trailer locks can be employed to help prevent theft. Unfortunately, trailer locks may not be one size fits all and thieves often find ways to work around these locks. While trailer locks and wheel chocks can help deter some thefts, these devices are often too easy to remove and require storage when not in use. This can make these devices cumbersome to use.

### BRIEF SUMMARY

There is provided a trailer. The trailer has a body frame and a tongue frame. The body frame has a front end, a rear end, a first side and a second side. The tongue frame has a trailer coupler at a first end and a second end that is movably attached to the body frame. The tongue frame is movable between an operational position and a stored position. The tongue frame is vertically offset from the body frame such that a top of the tongue frame is lower than a bottom of the body frame. In the stored position, at least the majority of the tongue frame is positioned below the body frame. In the operational position, the tongue frame extends forward from the body frame and the second end of the tongue frame remains below the body frame. A locking mechanism is provided for holding the tongue frame in the operational position. At least one axle is provided with each axle having a first wheel and a second wheel. The at least one axle is positioned perpendicular to a direction of travel of the trailer.

In one embodiment, the second end of the tongue frame fits between the first side and the second side of the body frame.

In one embodiment, a first roller movably engages the first side of the body frame and a second roller movably engages the second side of the body frame to allow the tongue frame to be moved between the operational position and the stored position.

In one embodiment, the first roller and the second roller support the second end of the tongue frame.

In one embodiment, the trailer has a first roller structure and a second roller structure. Each of the first roller structure and the second roller structure have an upper roller and a lower roller. The upper roller contacts a top of a lip on one of the first side and the second side of the body frame and the lower roller contacts a bottom of the lip on the first side or the second side. The first roller structure contacts the first side of the body frame and the second roller structure contacts the second side of the body frame.

In one embodiment, the tongue frame has a lock pin aperture that corresponds to a body lock pin aperture positioned on at least one of the first side and the second side of the body frame. A lock pin is insertable through the lock pin aperture and the body lock pin aperture to act as the locking mechanism.

In one embodiment, the body lock pin aperture is positioned adjacent the front end of the body frame for locking the tongue frame in the operational position.

In one embodiment, a guide ram is provided to maintain alignment of the tongue frame relative to the body frame during movement between the operational position and the stored position.

In one embodiment, a first portion of the guide ram telescopes into a second portion of the guide ram when the tongue frame is moved from the operational position to the stored position.

In one embodiment, at least one foot is attached to the front end of the body frame. The at least one foot is movable between a storage position and a ground engagement position.

In one embodiment, the tongue frame is movable between the operational position and the stored position using hydraulics.

In one embodiment, the tongue frame has a triangular shape such that the trailer coupler is positioned at an apex of the tongue frame and a base of the triangular shape is the second end being supported by the body frame.

In one embodiment, a stop is provided to prevent the tongue frame from being disconnected from the body frame.

In one embodiment, the trailer coupler is hingedly attached to the tongue trailer such that the trailer coupler is movable between a horizontal orientation and a vertical orientation. This movement may be completed manually, mechanically or with a hydraulic ram that is attached to an underside of the trailer coupler.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a top plan view of a trailer showing the operational position of the tongue frame and the stored position of the tongue frame in stippled lines.

FIG. 2 is a detailed perspective view of a front end of the trailer and first side.

FIG. 3 is a detailed perspective view of a front end of the trailer and second side.

FIG. 4 is a detailed rear elevation view, partially in section, of a side of the trailer.

FIG. 5 is a detailed rear elevation view, partially in section, of a side of the trailer.

FIG. 6 is a side elevation view of a front end of the trailer with the trailer coupler in a horizontal orientation and a vertical orientation in stippled lines.

### DETAILED DESCRIPTION OF THE PREFERRED EMBODIMENTS

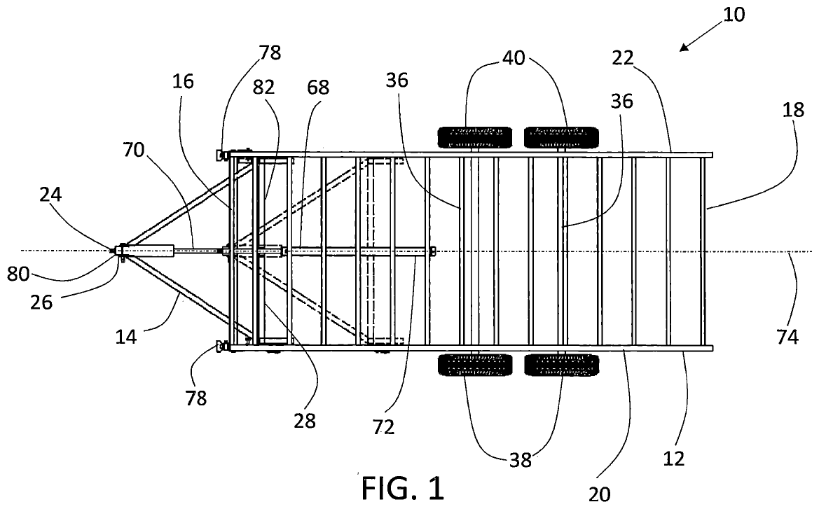

A trailer, generally identified by reference numeral 10, will now be described with reference to FIG. 1 through FIG. 6.

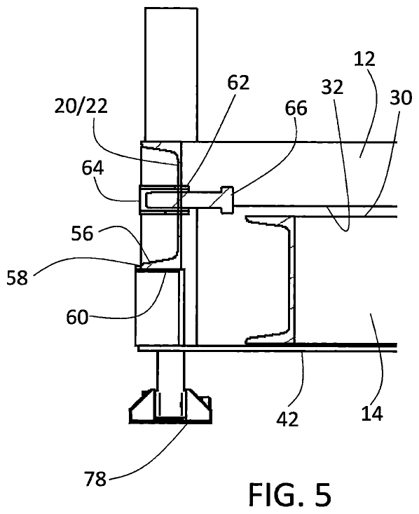

Referring to FIG. 1, a trailer 10 has a body frame 12 and a tongue frame 14. Body frame 12 has a front end 16, a rear end 18, a first side 20, and a second side 22. Tongue frame 14 has a trailer coupler 24 positioned at a first end 26 and a second end 28. Second end 28 is movably attached to body frame 12. Tongue frame 14 is movable between an operational position and a stored position. Tongue frame 14 is vertically offset from body frame 12 such that a top 30 of tongue frame 14 is lower than a bottom 32 of body frame 12. In the stored position at least a majority of tongue frame 14 is positioned below body frame 12. The stored position is shown in stippled lines in FIG. 1. In the operational position, tongue frame 14 extends forward from body frame with second end 22 of tongue frame 14 remaining below body frame 14. Tongue frame 14 may be movable relative to body frame 12 using manual, mechanical or hydraulic means known to a person skilled in the art. For example, a user may manually push or pull tongue frame 14, cranks, pulleys, gears, and levers may be used, or hydraulics such as rams may be used to move tongue frame 14 into the operational or stored positions. Referring to FIG. 5, a locking mechanism 34 is provided for holding tongue frame 14 in the operational position. Referring to FIG. 1, at least one axle 36 is provided. Each of axles 36 have a first wheel 38 and a second wheel 40. Axles 36 are positioned on body frame 12 perpendicular to a direction of travel of trailer 10.

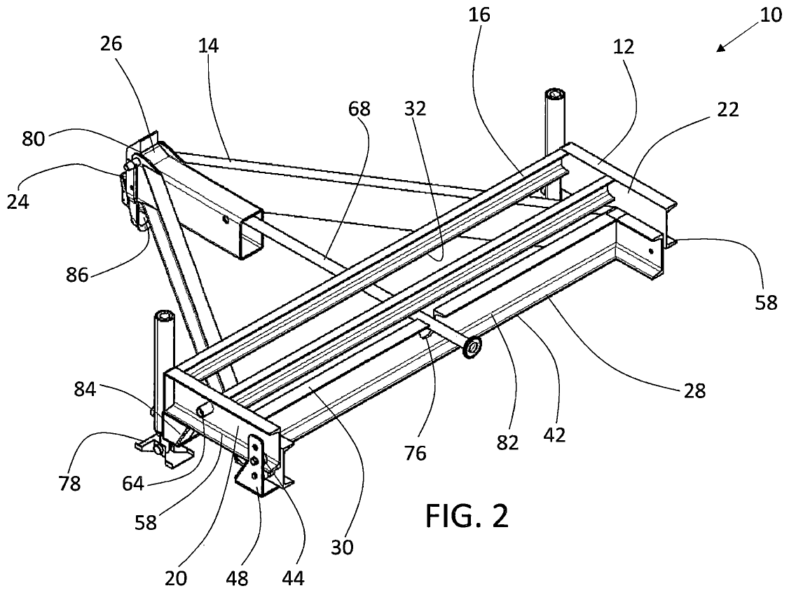

In the embodiment shown in FIG. 2, second end 28 of tongue frame 14 is sized such that it fits between first side 20 and second side 22 of body frame 12. This helps to maintain the overall width of trailer 10 and prevents unintentional snagging of tongue frame 14 as it moves from the operational position to the storage position and vice versa since it is protected by first side 20 and second side 22. As can be seen in the embodiment shown, first side 20 and second side 22 extend below bottom 32 of body 3Q frame 12. This allows top 30 of tongue frame 14 to be positioned between first side 20 and second side 22. It can be seen that a bottom 42 of tongue frame 14 extends below first side 20 and second side 22 when body frame 12 and tongue frame 14 have the same heights.

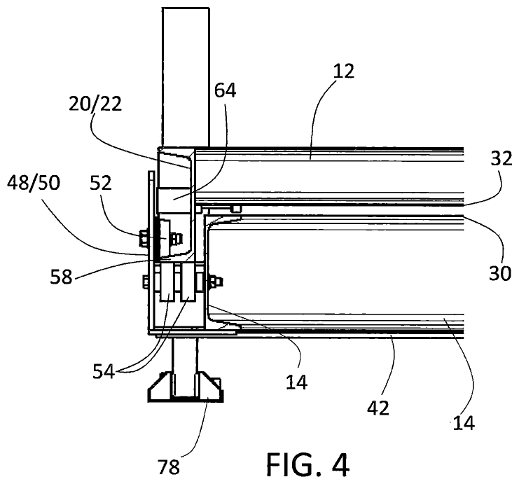

Referring to FIG. 4, a first roller 44 and a second roller 46 movably engage first side 20 and second side 22 of body frame 12, respectively, to allow tongue frame 14 to move between the operational position and the stored position. As can be seen, first roller 44 and second roller 46 provide support to second end 28 of tongue frame 14. This helps to maintain tongue frame 14 in a parallel relationship with body frame 12 and prevents second end from angling away from body frame 12 which could cause trailer coupler 24 to angle upwards. Misalignment of body frame 12 and tongue frame 14 could cause damage to both body frame 12 and tongue frame 14 due to contact between them. To help prevent misalignment, a guide rod 68 may be provided to maintain proper alignment of tongue frame 14 relative to body frame 12 during movement between the operational position and the stored position. In the embodiment shown in FIG. 1, guide ram 68 has a first portion 70 that telescopes into a second portion 72 when tongue frame 14 is moved from the operational position to the stored position. In the embodiment shown, guide ram 68 is positioned along a central axis 74 of trailer 10 with central axis extending from trailer coupler 24 to rear end 18 and being parallel to first side 20 and second side 22. A cut out 76 in top 30 of tongue frame 14 allows guide ram 68 to be positioned at bottom 32 of body frame 12. It will, however, be understood by a person skilled in the art that guide ram 68 may be positioned offset from center.

In the embodiment shown in FIG. 4, a first roller structure 48 and a second roller structure 50 allow tongue frame 14 to move relative to body frame 12. First roller structure 48 contacts first side 20 of body frame 12 and second roller structure 50 contacts second side 22 of body frame 12. Each of first roller structure 48 and second roller structure 50 have an upper roller 52 and a lower roller 54. In the embodiment shown, two lower rollers 54 are provided, however it will be understood by a person skilled in the art that a single roller 54 may be used. The use of two lower rollers 54 can provide additional stabilization of tongue frame 14 as it moves. Upper roller 52 contacts a top 56, shown in FIG. 5, of a lip 58 on first side 20 and second side 22 of body frame 12. Lower roller 54 contacts a bottom 60, shown in FIG. 5, of lip 58 of first side 20 or second side 22 of body frame 12. Upper roller 52 and lower roller 54 roll along lip 58 to facilitate movement of tongue frame 14 between operational position, and storage position.

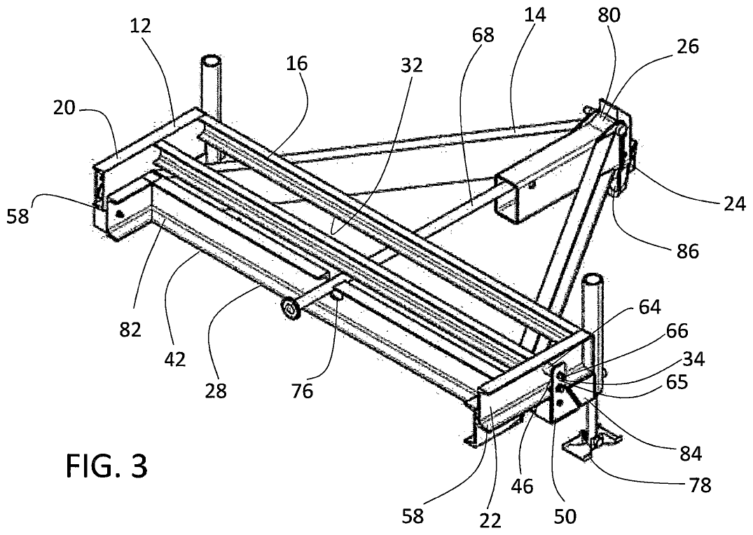

Referring to FIG. 5, tongue frame 14 has a lock pin aperture 62 that corresponds to a body lock pin aperture 64. Lock pin aperture 62 and body lock pin aperture 64 may be positioned on either first side 20, second side 22, or both first side 20 and second side 22. A lock pin 66 is insertable through lock pin aperture 62 and body lock pin aperture 64 to act as locking mechanism 34. In the embodiment shown in FIG. 2, body lock pin aperture 64 is positioned on first side 20 of body frame 12 adjacent front end 16. This allows tongue frame 14 to be locked in the operational position when lock pin aperture 62 is positioned adjacent second end 28 of tongue frame. It will be understood by a person skilled in the art that multiple lock pin apertures 62 and body lock pin apertures 64 may be provided to allow tongue body 14 to be locked in different positions relative to body frame 12. In the embodiment shown in FIG. 3, locking mechanism 34 has a body lock pin aperture 64, a roller structure aperture 65 that corresponds to body lock pin aperture 64 and a lock pin 66 insertable through body lock pin aperture 64 and roller structure aperture 65 to lock tongue frame 14 relative to body frame 12.

Referring to FIG. 2 through FIG. 5, at least one foot 78 may be attached to front end 16 of body frame. In the embodiments shown, two feet would be used. The first foot would be positioned adjacent a corner created by front end 16 and first side 20 of body frame 12 and the second foot would be positioned adjacent a corner created by front end 16 and second side 22 of body frame 12. If a single foot 78 is used, it should be positioned at a central point of front end 16 of body frame 12. It will be understood by a person skilled in the art that feet 78 may be positioned in other locations on body frame 12. A foot may also be provided adjacent trailer coupler 24 on tongue frame 14. Feet 78 are movable between a storage position and a ground engagement position. In the storage position, feet 78 are raised such that they do not interfere with the ground when trailer 10 is in motion or attached to a towing vehicle. In the ground engagement position, feet 78 accept the weight of trailer 10 and allow trailer coupler 24 to be raised above the corresponding coupler on a towing vehicle to allow trailer 10 to be hitched or unhitched from the towing vehicle. Movement between the storage position and the ground engagement position may occur through manual, mechanical or hydraulic means known to a person skilled in the art.

In the embodiments shown in FIG. 1 and FIG. 2, tongue frame 14 has a generally triangular shape with trailer coupler 24 positioned at an apex 80 of tongue frame 14 and a base 82 of the triangular shape being second end 28 of tongue frame 14 which is supported by body frame 12. It will be understood by a person skilled in the art that tongue frame 14 can be any shape deemed suitable as long as a trailer coupler 24 is provided and second end 28 of tongue frame 14 is appropriately supported by body frame 12.

Referring to FIG. 2, a stop 84 is provided to prevent tongue frame 14 from being disconnected from body frame 12. In the embodiment shown, stop 84 is a wall at a front end of first side 20 and second side 22. It will be understood by a person skilled in the art that stop 84 could be a raised shoulder, a bolt, or any other type of suitable item that acts as a stop.

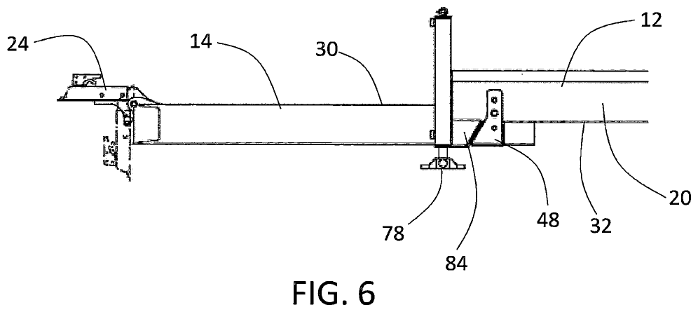

In the embodiment shown in FIG. 6, trailer coupler 24 may be hingedly attached to tongue trailer 14 such that trailer coupler 24 is movable between a horizontal orientation and a vertical orientation. In the horizontal orientation, trailer coupler 24 can be coupled to a tow vehicle. In the vertical orientation, trailer coupler 24 points downwards and is not connectable to a tow vehicle. Movement of trailer coupler 24 may be done through manual manipulation, mechanical manipulation or through the use of a hydraulic ram attached to an underside 86 of trailer coupler. In the embodiment shown in FIG. 2, guide rod 68 may also be configured to act as a hydraulic ram for movement of trailer coupler 24.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A trailer, comprising:
a body frame having a front end, a rear end, a first side and a second side;
a tongue frame having a trailer coupler at a first end and a second end being movably attached to the body frame, the tongue frame being movable between an operational position and a stored position, the tongue frame being vertically offset from the body frame such that a top of the tongue frame is lower than a bottom of the body frame, in the stored position at least the majority of the tongue frame is positioned below the body frame, in the operational position the tongue frame extends forward from the body frame and the second end of the tongue frame remains below the body frame;
a locking mechanism for holding the tongue frame in the operational position; and
at least one axle, each axle having a first wheel and a second wheel, the at least one axle being perpendicular to a direction of travel of the trailer.

2. The trailer of claim 1 wherein the second end of the tongue frame fits between the first side and the second side of the body frame.

3. The trailer of claim 1 wherein a first roller movably engages the first side of the body frame and a second roller movably engages the second side of the body frame to allow the tongue frame to be moved between the operational position and the stored position.

4. The trail of claim 3 wherein the first roller and the second roller support the second end of the tongue frame.

5. The trailer of claim 1 wherein the trailer has a first roller structure and a second roller structure, each of the first roller structure and the second roller structure comprising an upper roller and a lower roller, the upper roller contacting a top of a lip on one of the first side and the second side of the body frame and the lower roller contacting a bottom of the lip on the first side or the second side, the first roller structure contacting the first side of the body frame and the second roller structure contacting the second side of the body frame.

6. The trailer of claim 1 wherein the tongue frame has a lock pin aperture that corresponds to a body lock pin aperture positioned on at least one of the first side and the second side of the body frame, a lock pin being insertable through the lock pin aperture and the body lock pin aperture to act as the locking mechanism.

7. The trailer of claim 6 wherein the body lock pin aperture is positioned adjacent the front end of the body frame for locking the tongue frame in the operational position.

8. The trailer of claim 1 wherein a guide ram is provided to maintain alignment of the tongue frame relative to the body frame during movement between the operational position and the stored position.

9. The trailer of claim 8 wherein a first portion of the guide ram telescopes into a second portion of the guide ram when the tongue frame is moved from the operational position to the stored position.

10. The trailer of claim 1 wherein at least one foot is attached to the front end of the body frame, the at least one foot being movable between a storage positioned and a ground engagement position.

11. The trailer of claim 1 wherein the tongue frame is movable between the operational position and the stored position using hydraulics.

12. The trailer of claim 1 wherein the tongue frame has a triangular shape such that the trailer coupler is positioned at an apex of the tongue frame and a base of the triangular shape is the second end being supported by the body frame.

13. The trailer of claim 1 wherein a stop prevents the tongue frame from being disconnected from the body frame.

14. The trailer of claim 1 wherein the trailer coupler is hingedly attached to the tongue trailer such that the trailer coupler is movable between a horizontal orientation and a vertical orientation.

15. The trailer of claim 14 wherein the trailer coupler is movable between the horizontal orientation and the vertical orientation using a hydraulic ram attached to an underside of the trailer coupler.
